(19) United States
(12) Patent Application Publication
(10) Pub. No.: US 2007/0057882 A1
(43) Pub. Date: Mar. 15, 2007

(54) Liquid crystal display device

(75) Inventors: Kazuyuki Hashimoto, Kobe (JP); Minoru Shibazaki, Kobe (JP)

Correspondence Address: BIRCH STEWART KOLASCH & BIRCH, PO BOX 747, FALLS CHURCH, VA, 22040-0747, US

(73) Assignee: TPO DISPLAYS CORP.

(21) Appl. No.: 11/518,938

(22) Filed: Sep. 12, 2006

(30) Foreign Application Priority Data
Sep. 12, 2005 (JP) 2005-263552

(51) Int. Cl. G09G 3/36

(52) U.S. Cl. 345/88

(57) ABSTRACT

The present invention provides a driving circuit of a liquid crystal display device for obtaining an image without tone reversal, having satisfactory color tone, and high light emitting efficiency; and a liquid crystal display device including the same. The liquid crystal display device includes a liquid crystal display element array for obtaining a desired tone display when a voltage corresponding to the tone is supplied through a selected data line, and the liquid crystal elements are arranged for each color of red, green, and blue in a matrix form; a tone voltage generating part for generating an analog voltage corresponding to all tones of three colors; and a distributing part for sending the voltage corresponding to the tone of data line to the data line according to tone data value from the correspondence relationship between the tone data value and a voltage corresponding to the tone generated at the tone voltage generating part.

This application claims the benefit of Japan Patent Application Ser. No. 2005-263552, filed on Sep. 12, 2005.

### BACKGROUND OF THE INVENTION

1. Field of Invention

The present invention relates to a liquid crystal display device and, in particular, to a driving circuit of a data line in a liquid crystal display device.

2. Related Art

In an active matrix liquid crystal display device, a column driver selects a column line of the liquid crystal display element array so that a TFT is turned ON. Then, data related to the tone of each color is provided to a data line (a row line), and the transmissivity of the liquid crystal is changed to obtain a desired color according to the above-mentioned data.

Conventionally, red (R), green (G), and blue (B) are applied with the same tone versus voltage curve so that the liquid crystal display device can control the change of the brightness from completely white to completely black. Herein, the voltage data corresponding to the tone is applied to the data line as mentioned above.

However, regarding the transmissivity property of a color filter, the tone does not necessarily change proportionally when the high voltage corresponding to the large data is applied. Thus, the tone reversal may occur, and the luminance may be lowered. Further, the data value even may be increased. This phenomenon is significant particularly for blue, and is slightly recognized for green.

Therefore, if a RGB filter is configured by the same cell gap, the transmissivity is the lowest for the blue, followed by green, and the highest for the red. Thus, the blue may appear too strong and affect the white balance.

In order not to cause the tone reversal at the display screen of the display device, the cell thickness of the color liquid crystal display device is reduced. Further, a low voltage level is used to prevent the color tone reversal. Thus, the liquid crystal display is conventionally performed at a transmissivity below 35% of the maximum transmissivity.

Due to a preference of a halftone color, the change in the middle of the voltage change curve is varied to adjust the halftone and enhance a color reproducibility, particularly in a large-scale display. For example, the adjustment is referred to as a gamma adjustment, such that an intermediate value of a luminance curve can be changed without changing the values of the maximum level and the minimum level.

Furthermore, in order to adjust, in particular, the color tone of white to be a suitable tone, a limiter is arranged to suppress the maximum value of the driving voltage level of each color, and has been proposed in Japanese Patent Application Laid-Open No. 11-223807.

### SUMMARY OF THE INVENTION

Therefore, in the conventional liquid crystal display device, the cell thickness is reduced and slight dark with the lower luminance is used to prevent the tone reversal of the display screen, and thus the efficiency is low. In the conventional technique of employing the limiter, the transmissivity is reliably lowered and the luminance also cannot be increased.

The present invention provides a driving circuit of a liquid crystal display device for obtaining an image without a tone reversal, having a satisfactory color tone, and a high light emitting efficiency. The present invention also provides a liquid crystal display device including the same driving circuit mentioned above.

The liquid crystal display device according to the present invention includes a liquid crystal display element array, a tone voltage generating part and a distributing part. The liquid crystal display element array obtains a desired tone display when a voltage corresponding to the tone is supplied through a selected data line. The liquid crystal display elements are arranged for each color of red, green, and blue (RGB) in a matrix form. The tone voltage generating part generates an analog voltage corresponding to all tones of three colors. The distributing part sends the voltage corresponding to the tone of data line to the data line according to tone data value from the correspondence relationship between the tone data value and a voltage corresponding to the tone generated at the tone voltage generating part.

In the liquid crystal display device according to the present invention, the tone voltage is supplied to the selected data line based on the tone data in the distributing part, and based on the tone voltage generating part, and the relationship between the optimum setting tone voltage and the tone data. Thus the liquid crystal display circuit without tone reversal, with satisfactory color tone and high light emitting efficiency is realized simply and at low cost without increase in the circuit space by combining the existing circuit elements. In particular, the tone voltage generating part and the distributing part are operated in time sharing thereby reducing an occupying area.

### BRIEF DESCRIPTION OF THE DRAWINGS

The invention will become more fully understood from the detailed description given herein below illustration only, and thus is not limitative of the present invention, and wherein:

FIG. 1 is a schematic configuration view showing a first embodiment of the liquid crystal display device according to the present invention;

FIG. 2 is a schematic configuration view showing a second embodiment of the liquid crystal display device according to the present invention; and

FIG. 3 is a schematic configuration view showing a third embodiment of the liquid crystal display device according to the present invention.

### DETAILED DESCRIPTION OF THE INVENTION

The embodiments of the present invention will now be described in detail with reference to the drawings.

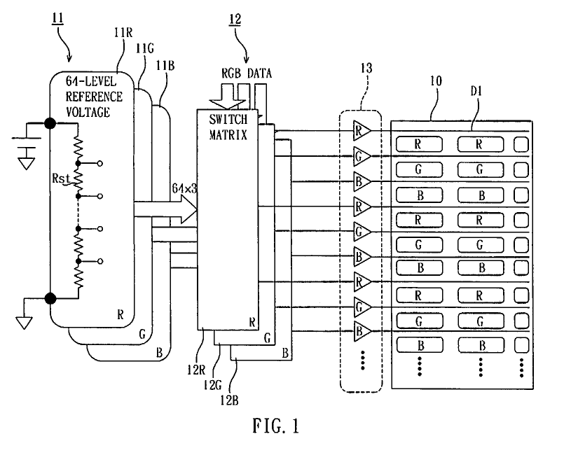

FIG. 1 is a block diagram showing a first preferred embodiment of the liquid crystal display device according to the present invention.

In the embodiment, a voltage generated in a tone voltage generating part 11 is provided for a data line D1 of a liquid crystal display element array 10 functioned as a display part. In the embodiment, the voltageis provided to the data line D1 via an analog buffer 13. Herein, the data line D1 receives a RGB data inputted by a distributing part 12.

The liquid crystal display element array 10 has a liquid crystal element including a color filter arranged in a matrix form. In FIG. 1, a red filter is indicated as R, a green filter is indicated as G, and a blue filter is indicated as B. A set of the RGB filters configures one display pixel.

As well known in the liquid crystal display element array 10, a drain of a thin-film transistor is connected to the liquid crystal display element arranged in an array form. The voltage corresponding to the tone is supplied to the data line. The data line is connected to each source of each transistor in a column direction. The transistors of the relevant rows are electrically conducted by the selection of a gate line connected to the gate of each transistor of a row direction. Thus a tone display is performed on the liquid crystal display element. Three liquid crystal display elements respectively including the red filter R, the green filter G, and the blue filter B form one set to configure one color pixel in the color liquid crystal display device. In each of the following diagram, the data line or the column line is drawn in the lateral direction for the sake of convenience.

Assuming a display of 64 tones is realized in the embodiment. The tone voltage generating parts 11R, 11G, 11B are arranged for each color. Each tone voltage generating parts 11R, 11G, 11B is a resistance voltage dividing circuit. Each tone voltage generating parts 11R, 11G, 11B has 64 resistors Rst connected in series and retrieves a predetermined voltage with a tap from each connecting point to obtain the voltage of different level. In this case, each resistor may have a constant resistance value, or have a resistance value may be changed according to the tone property.

When a certain data line is specified, the tone voltage supplied to the relevant line is retrieved from each tone voltage generating part 11 and distributed to the data line D1 by the distributing part 12. The distributing part 12 includes switch matrixes 12R, 12G, 12B arranged for each color. The switch matrixes 12R, 12G, 12B may be a decoder respectively. Each switch matrix decodes the RGB data in six bits corresponding to 64 tones that has been inputted and selects which tone voltage to be used. Then, each switch matrix obtains tone value address of each color and outputs the selected tone voltage. The tone voltage output signal is provided to the data line D1 through the analog buffer 13 of the relevant data line D1 to improve the waveform property and the similarity of the signal. The voltage corresponding to the tone is assigned to the tone value address specified by the decoder.

The relationship between the RGB data in the distributing part 12 and the tone voltage will be retrieved has the correspondence relationship. The correspondence relationship is defined in advance so that tone reversal would not occur on the display screen. Further, high voltage may be used in this embodiment. Thus, in this case, the luminance would not regularly increase with the voltage when the reverse between blue and green occur particularly.

Therefore, in the liquid crystal display device, the retrieval of the tone voltage to be supplied to the data line and the supply of the same to the specified data line are synchronously performed in synchronization with the selection of the data line. The switching of data line, retrieval of tone voltage by the tone voltage generating part, and supply of tone voltage to the data line by the distributing part are performed in synchronization. The tone voltage generation in the tone voltage generating part, and the supply to the data line in the distributing part are performed with the operation time shifted for each color in one data line selection period.

In the embodiment, the tone voltage generating part 11 and the distributing part 12 are respectively arranged for each color, and thus the operation can be reliably performed.

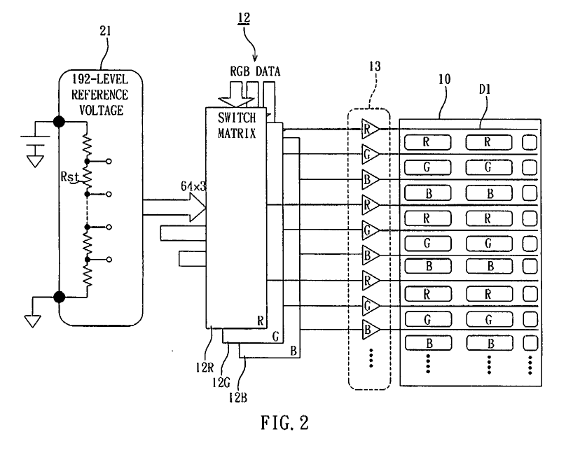

FIG. 2 shows a second preferred embodiment of the invention. In this embodiment, the tone voltage generating part is changed, but the configuration and the feature of the distributing part 12 and the subsequent parts are exactly the same as in the first preferred embodiment of FIG. 1. Thus, the explanation thereof is omitted.

In the present embodiment, the tone voltage generating part 11 of 64 tones provided for each color in the first embodiment of FIG. 1 is arranged as one tone voltage generating part 21 to obtain the tone voltage in 64×3=192 levels. Therefore, these tone voltages can be commonly used among the three colors. However, the same voltage cannot be used simultaneously among a plurality of colors. This is because the configuration of the distributing part 12 is the same as the first embodiment of FIG. 1, and each color is driven simultaneously.

192 lines are necessary for the connection between the tone voltage generating part 21 and the distributing part 12, and 192 lines are substantially not different from the first embodiment of FIG. 1.

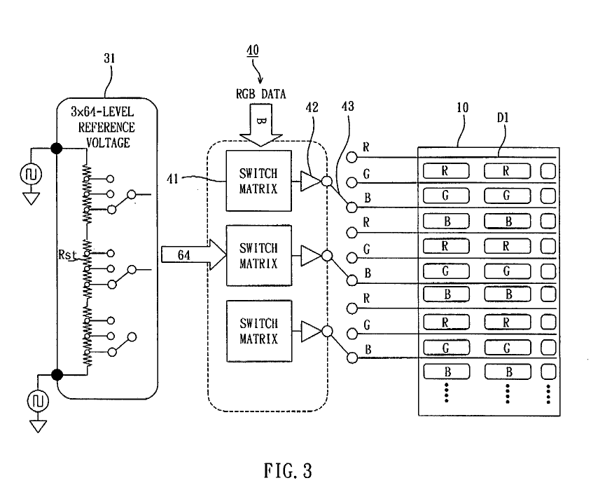

FIG. 3 shows a third embodiment in which the example of FIG. 2 is further modified.

In the present embodiment, a tone voltage generating part 31 retrieves 192 tones described in FIG. 2, but has a configuration of generating the tone voltage for each color in each at the three divided periods through time sharing in one data line selection period.

Therefore, although the tone voltage that can be outputted in 192 levels, 64 tones are outputted and sent to a distributing part 40 of the next stage in 64 lines.

Furthermore, since the tone to be outputted is 64, the tone that can be produced may be in 64 levels. Furthermore, since one tone voltage generating part is commonly used among each color through time sharing, the same tone voltage can be used for different colors.

The distributing part 40 includes a switch matrix 41, an analog buffer 42, and a switch 43. The switch matrix 41 selects the tone voltage corresponding to the tone from the inputted RGB data. The analog buffer 42 shapes the outputted tone voltage waveform. The switch 43 operates as a connecting part and selects the specified data line D1 and providing the tone voltage signal thereto.

This distributing part also operates in time sharing. That is, the distributing part distributes the tone voltage to the data line of the target color at different times for the data line of each color contained in the relevant data line during one data line selection period. The tone voltage is outputted from the tone voltage generating part. The voltage generation of the tone voltage generating part for each color of RGB, and the selective connection to the data line of each color by the connecting part for the voltage are time division controlled for each color.

The control becomes complicating in the present example since the operation is performed in time sharing. But since the tone voltage generating part 31 and the distributing part 40 are commonly used among each color, and the number of wirings for connecting the tone voltage generating part 31 with the distributing part 40 may be the same as the number of tones for one color, the area occupied by the wires is greatly reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A liquid crystal display device, comprising:
a liquid crystal display element array for obtaining a desired tone display when a voltage corresponding to the tone is supplied through a selected data line, wherein the liquid crystal display element array has liquid crystal display elements arranged for each color of red, green, and blue (RGB) in a matrix form;
a tone voltage generating part for generating an analog voltage corresponding to all tones of three colors; and
a distributing part for sending the voltage corresponding to the tone of the data line to the data line according to tone data value from the correspondence relationship between the tone data value and a voltage corresponding to the tone generated at the tone voltage generating part.

2. The liquid crystal display device according to claim 1, wherein the tone voltage generating part is a resistance voltage dividing circuit.

3. The liquid crystal display device according to claim 2, wherein the resistance voltage dividing circuit is arranged for each color, and includes a voltage retrieving tap of the number of tones required in each color.

4. The liquid crystal display device according to claim 2, wherein the resistance voltage dividing circuit is a single circuit including a voltage retrieving tap of three times the number of tones required in each color.

5. The liquid crystal display device according to claim 1, wherein the distributing part includes a decoder for decoding the RGB data and obtaining tone value address of each color, and a connecting part for selectively sending the voltage corresponding to the tone assigned to the tone value address specified by the decoder to the data line.

6. The liquid crystal display device according to claim 1, wherein the voltage generation of the tone voltage generating part for each color of RGB, and the selective connection to the data line of each color by a connecting part for the voltage are time division controlled for each color.

7. The liquid crystal display device according to claim 1, wherein switching of data line, retrieval of tone voltage by the tone voltage generating part, and supply of tone voltage to the data line by the distributing part are performed in synchronization.

8. The liquid crystal display device according to claim 1, wherein the tone voltage generation in the tone voltage generating part, and the supply to the data line in the distributing part are performed with the operation time shifted for each color in one data line selection period.
